(19) United States
(12) Patent Application Publication
(10) Pub. No.: US 2025/0207543 A1
(43) Pub. Date: Jun. 26, 2025

(54) FUEL INJECTION AND MIXING APPARATUS FOR PULSE COMBUSTORS

(71) Applicant: North American Wave Engine Corporation, Baltimore, MD (US)

(72) Inventor: Daanish MAQBOOL, North Bethesda, MD (US)

(21) Appl. No.: 18/990,717

(22) Filed: Dec. 20, 2024

Related U.S. Application Data
(60) Provisional application No. 63/613,632, filed on Dec. 21, 2023.

(51) Int. Cl. F02K 9/52; F02C 7/22; F02K 7/02

(52) U.S. Cl. CPC F02K 9/52; F02C 7/22; F02K 7/02

(57) ABSTRACT

A system and method is disclosed for improving fuel injection systems for pulse combustors that reduce protrusions that can detrimentally impact the performance of pulsejet aircraft to which such pulse combustors are associated. The fuel injection system disclosed herein can be used with a pulse combustor to minimize protrusions, with the pulse combustor including at least an inlet pipe, a combustion chamber, an exhaust pipe, an ignition device, a fuel supply system, with the fuel injection system.

### CROSS-REFERENCES TO RELATED APPLICATIONS

This application claims the benefit of priority to U.S. Provisional Application Ser. No. 63/613,632, filed Dec. 21, 2023, the disclosure of which is incorporated by reference in its entirety.

### FIELD OF THE INVENTION

The present invention relates to fuel injection, particularly fuel injection for pulsejet engines.

### BACKGROUND OF THE INVENTION

A conventional valveless-type combustor or pulsejet engine preferably includes a combustion chamber, an inlet pipe, fuel injector(s), spark plug (or other ignition device), and an exhaust pipe, which is sometimes referred to as a “tailpipe”. These conventional pulsejet engines may be configured straight or U-shaped. The combustion chamber, inlet pipe and exhaust pipe are often cylindrical. Typically, the diameters of the inlet and exhaust pipes are less than the diameter of the combustion chamber. Further, the length of the inlet pipe is typically less than the length of the exhaust pipe.

When a fuel and air mixture is introduced into the combustion chamber, the spark plug or other ignition device is activated to produce a high-temperature source that ignites the fuel/air mixture. The ensuing combustion process causes a rise in the temperature and pressure of the gases inside the combustion chamber. These gases then expand and escape through the inlet and exhaust pipes. The high velocity of the escaping gases causes an overexpansion and negative pressure inside the combustion chamber. This negative pressure then reverses the direction of the flow in the inlet and exhaust pipes. Fresh air sucked in from the atmosphere via the inlet pipe reaches the combustion chamber because of its shorter length mixes with the fuel that is injected either in the inlet pipe or directly into the combustion chamber. The new fuel/air mixture enters the combustion chamber where it encounters the high-temperature combustion products from the previous combustion event. These combustion products ignite this new fuel/air mixture to produce another combustion event and the process repeats indefinitely as long as there is fuel being injected into the combustion chamber as described.

In tracking the combustion events, there is also flow reversal in the exhaust pipe due to the negative pressure in the combustion chamber. However, due to the length of the exhaust pipe, the fresh air drawn in from the atmosphere does not typically reach the combustion chamber before the next combustion event. Also, the spark plug is only needed to start initial operation of the engine, and is not necessary to sustain the operation of the engine. Therefore, the spark plug can be turned off once the engine is started.

The result of the working cycle of a pulse combustor is that the inlet and exhaust ends produce oscillating flows, i.e., intermittent jets of gas that emanate from them and are responsible for thrust generation. The exhaust pipe usually generates the greatest amount of thrust, but the inlet pipe can also generate a significant amount of thrust, which typically would be on the order of two-thirds (⅔) the thrust generated by the exhaust pipe. Therefore, in order to capture the thrust generated by both the inlet and exhaust pipes, both pipes should be pointed in the same direction. Typically, this is accomplished by the exhaust pipe being bent so that the inlet pipe points in the same direction as the exhaust pipe, giving the engines a “U-shape”.

Pulse combustors can have a number of different forms. Some have multiple inlets, while others have inlets that are perpendicular to the exhaust pipe. Nevertheless, all these embodiments have the same working principle as described above.

Advantages of pulse combustors include the ability to draw in fresh air and sustain operation without any external machinery or moving parts. Pulse combustors have been used as thrust-producing devices, in which case they are commonly referred to as “pulsejet”, “pulse jet” or “wave” engines. Pulsejet engines have a long history and have been used to propel several types of aircraft over the last century. They are often characterized by a diverging exhaust pipe to aid in thrust production.

In addition to the main combustor (engine) components described earlier, there are apparatuses for the supply and injection of fuel into the engine. Common apparatuses for fuel supply and injection into engines include fuel rails, which hold a circulating supply of pressurized fuel for injection into the engine, and electronic fuel injectors, which are long, electrically controlled devices that draw pressurized fuel from the fuel rail and inject it into an engine. Fuel injectors commonly have a spring-loaded pintle resting in a hole that is connected to a solenoid. When the solenoid is energized by current, it lifts the pintle to create an opening between the pintle and the hole which allows pressurized fuel to flow out of the fuel injector and into the engine.

It is usually advantageous to inject fuel at an angle to the direction of air flow inside the engine (and therefore, at an angle to the engine inlet and/or combustion chamber axes) to facilitate fuel-air mixing. However, installing the fuel injector at an angle to the air flow causes the injector to protrude outward from the engine. Outward protrusion of the fuel injector is undesirable because it increases the physical dimensions of the engine. Furthermore, the outward protrusion of the injectors away from the engine axis also necessitates a larger fuel rail which further increases the physical dimensions of the engine. An increase in the physical dimensions of the engine makes it more complicated to integrate the engine with an airframe and increases drag with forward airspeed. For these reasons, it is desirable to create a fuel injection apparatus with minimal physical dimensions that protrude outward from the engine, i.e., that is, keep it compact.

### SUMMARY OF THE INVENTION

The present invention is directed to a fuel supply and injection system and method for pulsejet engine systems that is compact and allows for improved engine performance. The pulsejet engine incorporating the system and method of the present invention includes an inlet pipe, combustion chamber, exhaust pipe, spark plug or other ignition device, and a fuel injection assembly that includes fuel injector(s), redirection nozzles, and a circular fuel rail. Fuel injectors are installed along the inlet axis and around the inlet pipe in an axisymmetric fashion, such that they feed fuel into the fuel redirection nozzles. The fuel redirection nozzles are installed inside the combustion chamber. The fuel redirection nozzles receive fuel from the fuel injectors and inject it radially into the combustion chamber centerline. A circular fuel rail is placed behind the injectors (and therefore, around the inlet pipe) to supply pressurized fuel to the injectors. In operation, when the fuel injectors are activated (energized), pressurized fuel is drawn from the fuel rail and injected into the combustion chamber. The pressurized fuel makes its way via the fuel injectors and into the fuel redirection nozzles, which spray it inward towards the combustion chamber centerline. This arrangement allows for compactness of the overall fuel supply and injection apparatus while providing adequate engine performance.

### BRIEF DESCRIPTION OF THE DRAWING(S)

FIG. 1 shows a representative side view of a U-shape pulse combustor and an embodiment of the present invention.

FIG. 2 shows a representative top left perspective view of a U-shape pulse combustor and an embodiment of the present invention.

FIG. 3 shows a representative aft view of a U-shape pulse combustor and an embodiment of the present invention.

FIG. 4 shows a representative perspective view of an embodiment of a fuel redirection insert of the present invention.

FIG. 5 shows a representative perspective view of an embodiment of a fuel rail assembly of the present invention.

FIG. 6 shows a close-up of a representative side view of an embodiment of the present invention.

FIG. 7 shows a close-up of a representative top left perspective view of an embodiment of the present invention.

FIG. 8 shows an exploded representative side view of an embodiment of the present invention to show the assembly of components.

FIG. 9 shows an exploded representative top left perspective view of an embodiment of the present invention to show the assembly of components.

### REFERENCE NUMERALS IN THE DRAWING(S)

| Ref. No. | Description |
|---|---|
| 10 | Pulse Combustor |
| 12 | Inlet Pipe |
| 14 | Combustion Chamber |
| 16 | Exhaust Pipe |
| 20 | Fuel Injection Assembly |
| 22 | Fuel Injector(s) |
| 24 | Fuel Rail Bolt |
| 30 | Fuel Redirection Insert |
| 32 | Fuel Redirection Baseplate |
| 34 | Fuel Redirection Plenum |
| 36 | Fuel Redirection Nozzle |
| 40 | Fuel Rail Assembly |
| 41 | Injector Boss(es) |
| 43 | Fuel Passage |
| 45 | Fuel Flow Port(s) |
| 47 | Measurement Port(s) |
| 49 | Bolt Hole(s) |

### DETAILED DESCRIPTION OF THE INVENTION

With respect to this Specification, it is understood that the terms “pulse combustor,” “pulse jet engine,” “pulse jet,” “pulsejet engine,” “pulsejet,” or “wave engine” are used synonymously. It is understood that a pulsejet or pulse jet engine is a pulse combustor that is used for thrust production. It is also understood that wave engines are a class or family of engines, within which a type of engine is a pulsejet engine.

Pulse combustors, particularly when used as thrust-producing devices, i.e., as pulsejets, should be as compact as practically possible to minimize aerodynamic drag and ease integration with airframes. In some configurations, the fuel supply and injection components of the engine can protrude outward from the combustion chamber and/or inlet pipe and it is desirable to install or package these as tightly as possible within the frontal projected perimeter of the combustion chamber to minimize aerodynamic drag and installation complexity.

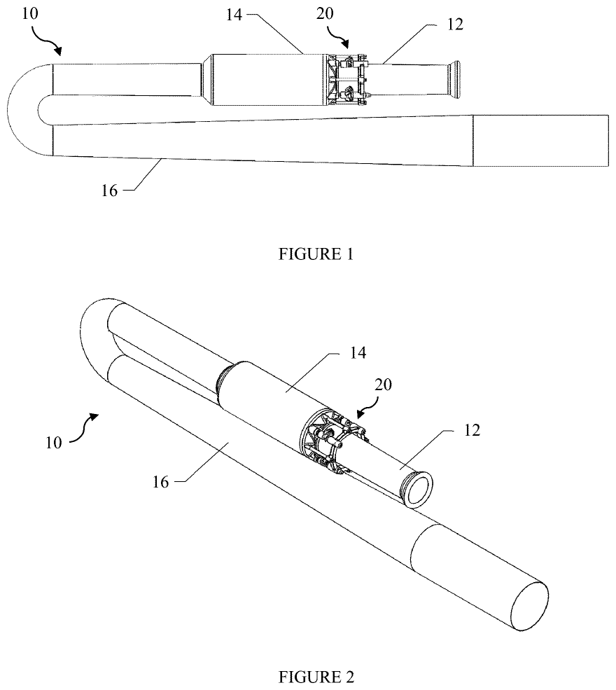

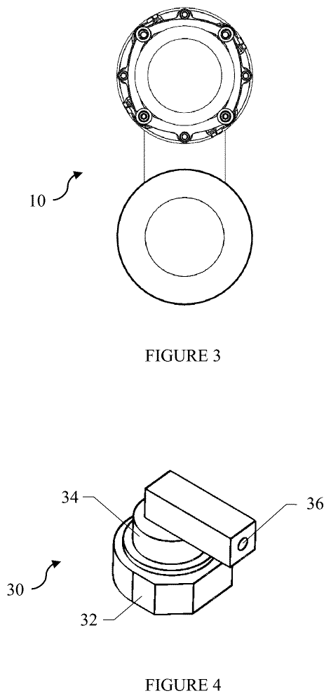

Generally, at 10, FIGS. 1, 2 and 3 show representative side, perspective and aft views of a pulse combustor and an embodiment of the present invention. Preferably, pulse combustor 10 includes inlet pipe 12 connected to one open end of combustion chamber 14. The other open end of combustion chamber 14 is connected to exhaust pipe 16. Pulse combustor 10 also includes fuel injection assembly 20 connected to combustion chamber 14 for supplying and injecting fuel into combustion chamber 14. Further, pulse combustor 10 includes a spark plug or other ignition device (not shown) for igniting the fuel/air mixture in combustion chamber 14. This component is known in the art.

FIG. 4 is a representative perspective view of fuel redirection insert 30. Fuel redirection insert 30 consists of a fuel redirection baseplate 32 which has a seat for fuel injector(s) 22 and an opening to allow for the fuel to pass through. Fuel redirection baseplate 32 is connected to fuel redirection plenum 34, which is then connected to fuel redirection nozzle 36, which is oriented at an angle nominally 90 degrees from fuel injector(s) 22, i.e., orthogonal to the combustion chamber 14 centerline.

FIG. 5 is a representative perspective view of fuel rail assembly 40. Fuel rail assembly consists of injector boss(es) 41 arranged in axisymmetric fashion and connected to one another via fuel passage 43 which creates a fluidic connection between injector boss(es) 41 and allows fuel to flow between injector boss(es) 41. Nominally two injector boss(es) are also connected to fuel flow port(s) 45 for fuel intake and exhaust (also known as supply and return in the art). Generally, one fuel flow port 45 is in fluidic connection with a pressurized fuel source and the other fuel flow port 45 is in fluidic connection with a fuel pressure regulator. Fuel passage 43 is internally blocked between fuel flow ports 45 to force the fuel to circulate past all injector boss(es) 41. The injector boss(es) 41, which is/are not connected to fuel flow ports 45 are connected to threaded measurement port(s) 47, which can be used to install instrumentation for the measurement of fuel properties such as temperature and pressure. In some embodiments, the fuel passage 43 can include a circular, an annular, or a ring shape. In some embodiments, the injector boss(es) 41 can include a hollow and cylindrical shape.

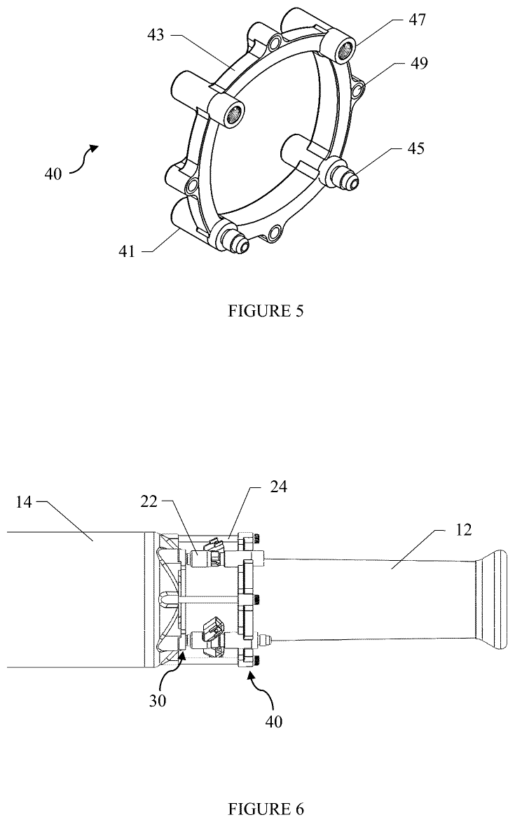

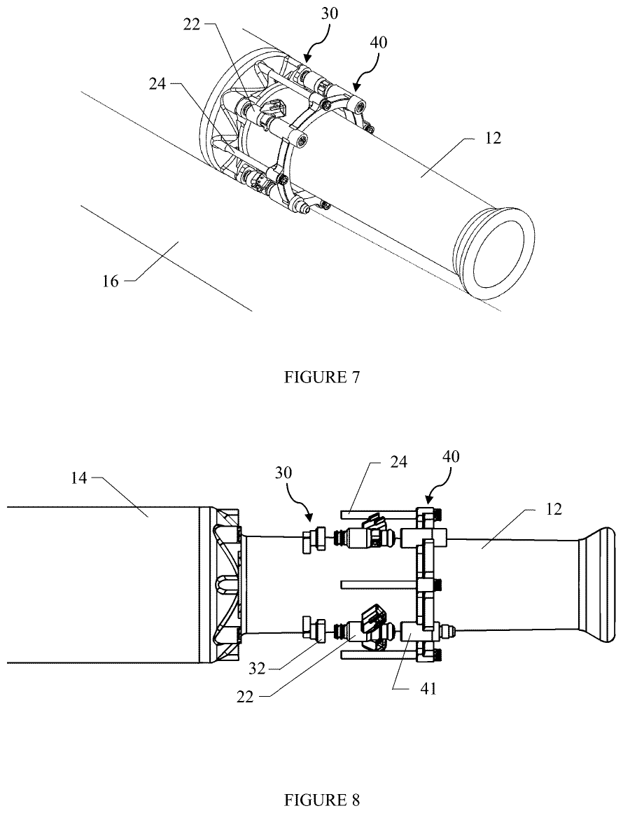

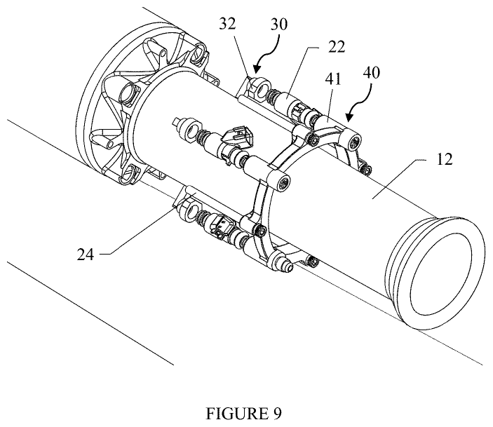

FIGS. 6 and 7 are close-up side and perspective views of pulse combustor 10 to show details of fuel injection assembly 20. FIGS. 8 and 9 are exploded side and perspective views of pulse combustor 10 to show details of fuel injection assembly 20. One end (the fuel ingress end) of fuel injector(s) 22 is installed into injector boss(es) 41 of the fuel rail assembly 40. The other end (the fuel egress end) of fuel injector(s) 22 is installed in the fuel redirection baseplate 32 of fuel redirection insert 30, and fuel redirection insert 30 is installed into combustion chamber 14. Fuel rail bolt 24 goes through bolt hole 49 of the fuel rail assembly 40 and threads into combustion chamber 14 to press and hold together fuel redirection insert 30 and components of fuel rail assembly 40.

In normal operation, fuel flows from a high pressure source, such as a fuel pump, into a fuel flow port 45. This pressurized fuel then flows around fuel passage 43 and exits the fuel rail assembly at another fuel flow port 45. The net result is that there is a circulating supply of pressurized fuel at all times inside fuel passage 43. This provides fuel injector(s) 22 with a constant supply of pressurized fuel via injector boss(es) 41 which is/are in fluidic connection with fuel passage 43. When fuel injector(s) 22 is/are activated and opened, fuel flows through fuel injector(s) 22 and is injected through the opening in fuel redirection baseplate 32 to enter fuel redirection plenum 34, and subsequently fuel redirection nozzle 36 situated inside the combustion chamber. As fuel exits fuel redirection nozzle 36, it is sprayed inward toward the centerline of the combustion chamber, for effective fuel-air mixing and combustion. This allows for a compact fuel injection assembly/apparatus to produce adequate pulse combustor operation.

The present invention includes other embodiments which may or may not have been explicitly described above but adhere to the same principle of operation. For example, fuel redirection insert 30 and/or fuel redirection nozzle 36 may be permanently attached/affixed to, i.e., become an integral part of, combustion chamber 14. Another example is the fuel redirection nozzle 36 spraying at an angle different from 90 degrees from the centerline of combustion chamber 14. While this may change the specifications of the apparatus, it does not change the basic concept of the device and principle of operation, i.e., that fuel is injected via a fuel injector and then made to turn inward, and then sprayed toward the centerline of the combustion chamber. Any alternative physical configurations are within the scope of the present invention.

The described embodiments of the present invention in this Specification are meant to be representative of the use of fuel injectors and fuel nozzles with a pulsejet engine. However, someone of ordinary skill in the art would understand other embodiments are possible that will be within the scope of the present invention. Accordingly, what is described in this Specification is meant for purposes of description not limitation.

1. A fuel injection system for use with a pulse combustor to minimize protrusions, with the pulse combustor including at least an inlet pipe, a combustion chamber, an exhaust pipe, an ignition device, a fuel supply system, with the fuel injection system, comprising:
A. a fuel rail assembly disposed around the inlet pipe and in fluid communication with an interior of the combustion chamber through a first end of the combustion chamber, with the fuel rail assembly comprising:
i. a hollow fuel passage that rings the inlet pipe for passage of pressurized fuel around the fuel passage,
ii. connection tabs mounted on the fuel passage for facilitating connecting the fuel rail assembly to the combustion chamber,
iii. one or more injector bosses disposed around, and in fluid communication with, the fuel passage, with each injector boss having a first end, second end, and a center axis parallel to a center axis of the inlet pipe, and with the second end directed toward the combustion chamber, and
iv. at least two fuel ports with each connected to the first end of an injector boss, with the fuel ports being in fluid communication with the fuel passage through the injector boss;
B. a fuel injector connected to the second end of each injector boss and in fluid communication with the fuel passage through the injector boss;
C. a fuel redirection insert connected to, and in fluid communication with, a distal end of each fuel injector, with each fuel redirection insert having a nozzle for redirecting a flow of fuel being output from the nozzle at an angle to the center axis of an associated injector boss; and
D. a proximal end of combustion chamber having an opening for sealingly receiving therein and therethrough each fuel redirection insert, and the fuel redirection insert when so disposed, fuel from the fuel passage can be injected into the combustion chamber at an angle.

2. The system as recited in claim 1, wherein the fuel passage includes a circular shape.

3. The system as recited in claim 1, wherein the injector bosses include hollow and cylindrical shapes.

4. The system as recited in claim 1, wherein the fuel redirection insert further includes
A. a baseplate for connecting the fuel redirection insert to the injector,
B. a fuel redirection plenum connected to the baseplate for receiving pressured fuel in the fuel redirection insert, and
C. the nozzle connected to the plenum for disbursing pressurized fuel into the combustion chamber.

5. The system as recited in claim 4, wherein the nozzle disburses pressurized fuel into the combustion chamber at an less than 90°.

6. The system as recited in claim 4, wherein the nozzle disburses pressurized fuel into the combustion chamber at a 90° angle.

7. The system as recited in claim 4, wherein the nozzle disburses pressurized fuel into the combustion chamber at an angle greater than 90°.

8. The system as recited in claim 1, wherein one or more measurement ports are disposed around, and in fluid communication with, the fuel passage.

9. The system as recited in claim 8, wherein a measurement port includes at least one open end for receiving instruments for measuring fuel properties.

10. The system as recited in claim 9, wherein measurement instruments include fuel pressure and temperature instruments.

11. The system as recited in claim 1, wherein of the at least two fuel ports, a first fuel port is connected to a source of pressurized fuel to be injected into the combustion chamber.

12. The system as recited in claim 1, wherein of the at least two fuel ports, a second fuel port is connected to a pressure regulator for regulating a pressure of pressurized fuel in the fuel passage.
